(19) United States
(12) Patent Application Publication
(10) Pub. No.: US 2024/0263031 A1
(43) Pub. Date: Aug. 8, 2024

(54) DIGITAL INK COMPOSITION

(71) Applicant: Kornit Digital Ltd., Rosh HaAyin (IL)

(72) Inventors: Mazi AMIAL-LEVY, Petah Tikva (IL); Ira YUDOVIN-FARBER, Rehovot (IL); Benjamin DAYAN, Ashkelon (IL); Jacob MANN, Zoran (IL)

(73) Assignee: Kornit Digital Ltd., Rosh HaAyin (IL)

(21) Appl. No.: 18/573,450

(22) PCT Filed: Aug. 2, 2022
(86) PCT No.: PCT/IL2022/050834

§ 371 Date: Dec. 22, 2023

Related U.S. Application Data
(60) Provisional application No. 63/229,646, filed on Aug. 5, 2021.

(51) Int. Cl. C09D 11/38; C09D 11/322; C09D 11/324; D06P 1/50; D06P 1/62; D06P 5/30

(52) U.S. Cl. CPC C09D 11/38; C09D 11/322; C09D 11/324; D06P 1/50; D06P 1/621; D06P 5/30

(57) ABSTRACT

Provided herein is a digital ink composition containing a minimal amount of volatile organic compounds (VOC), and a method for reducing VOC emission during digital printing of an image on a fabric.

### RELATED APPLICATION

This application claims the benefit of priority of U.S. Provisional Patent Application No. 63/229,646 filed Aug. 5, 2021, the contents of which are incorporated herein by reference in their entirety.

### FIELD AND BACKGROUND OF THE INVENTION

The present invention, in some embodiments thereof, relates to water-based pigmented inks formulated for inkjet printing on fabrics, and more particularly, but not exclusively, to digital inkjet inks with low volatile organic compounds contents.

In recent years there has been a growing demand worldwide for industrial processes and materials that do not harm the environment that goes along the lines of sustainability. Among others, the textile industry is considered one of the most polluting industries. Most of the pollution is mainly caused by heavy use of large amounts of contaminated water excreted with various substances such as dyes, detergents, bleach materials and heavy metals. Contaminated water requires a dedicated facility that involves high operating cost and energy consumption that also contributes to environmental pollution. In addition, the production of silk printing nets and their reusable cleaning requires the use of volatile organic compounds (VOC) that are a source of atmospheric pollution.

The carrier makes up the bulk of the digital ink composition. Nowadays inks tend to be developed as water-based inks, meaning that the carrier is an aqueous solution, rendering these water-based inks more suitable for requirements of the Clean Air Act. Still, organic solvents are still used as co-solvents in aqueous ink compositions, and these are typically chosen from those used in other industries such as coatings and paints. With the race for cleaner industry, special attention has been paid to ink formulations that are designed to minimize waste, emissions, and for the reduction of VOCs due to of environmental and health concerns that apply to co-solvents having a low boiling point.

PCT/IL2018/051107, by the present assignee, which is incorporated herein by reference in its entirety, provides a method for digitally printing an image on a substrate in the form of a film attached to the surface of the substrate, such that the film is characterized by improved adhesion and fastness properties also in regions of sparse printing, the method includes digitally printing the image using colored ink composition(s) that comprises a particulate colorant and a binder, and digitally printing selectively a transparent colorless ink composition that includes a binder on regions of impaired adhesion of the image due to sparse printing, such that all parts of the image receive sufficient binding reagents according to a pre-determined threshold.

Direct inkjet printing on fabrics typically involves forming a film on the surface of the substrate such that the pigment particles are embedded in the film and the film is affixed to the substrate. Most properties of the image (film), such as color definition, resolution and gamut (typically referred to as image quality), film adherence and stability (typically referred to as wash fastness), smoothness/softness and other physical/mechanical properties (typically referred to as “hand feel”), are directly influenced by the amount and composition of the inks that are jetted onto the substrate during the printing process, while other properties are related to the type of substrate, optional pre-treatment it undergoes before printing, and post-printing process steps, such as curing.

Problems associated with inkjet printing liquid inks directly on absorptive substrates, such as textile and garments, have been mitigated in U.S. Patent Application Publication No. 20150152274, and PCT Application Nos. WO 2005/115089 and WO 2005/115761, by the present assignee that are incorporated by reference as if fully set forth herein. These documents teach a process, a composition and an apparatus for printing an image on an absorptive surface, such as an untreated (a substrate that has not been pre-treated chemically) textile piece, that includes applying a wetting composition on the surface which is capable of interfering with the engagement of a liquid ink composition with the binding sites of the surface. According to the processes taught in these patent applications, once the wetting composition is applied, the liquid ink composition is applied while the surface is still wet. Using this process, a vivid color image is formed on the absorptive surface. These patent applications, however, fail to address printing a color image on an absorptive dark surface.

Multi-part ink compositions, which are based on contacting an immobilizing composition and a colored ink composition on the surface of an untreated substrate, so as to congeal the colored ink composition on the substrate, thereby minimizing feathering and soaking thereof into absorptive substrates, are also taught in U.S. patent application Ser. No. 11/588,277 (U.S. Patent Application Publication No. 20070104899), and U.S. patent application Ser. No. 11/606,242 (U.S. Patent Application Publication No. 20070103529), all of which are incorporated by reference as if fully set forth herein.

Problems associated with inkjet printing transparent liquid inks directly on dark substrates, such as dyed textile and garments, have been mitigated in U.S. Pat. No. 7,134,749, by the present assignee, which is incorporated by reference as if fully set forth herein. This document teaches a method and an apparatus for color printing on an untreated dark textile piece that includes digitally printing, by means of an inkjet printer head, an opaque white ink layer directly onto the untreated dark textile piece, and digitally printing a colored image on the white ink layer.

U.S. Pat. No. 8,540,358, by the present assignee, which is incorporated by reference as if fully set forth herein, teaches an inkjet ink compositions for forming an image in a form of an elastic film attached to a surface of an untreated stretchable and/or flexible substrate and processes utilizing same for inkjet printing color images on various substrates such as colored and absorptive or impregnable stretchable materials, which are characterized by heightened efficiency in process time, ink and energy consumption, as well as products having durable, wash-fast and abrasion-fast images printed thereon by the process, are disclosed.

Fabric inkjet printing technology using coagulating water-based pigment inks reduces water consumption because this technology is carried out without the need for pre-treatment of the fabric and without the need for washing after printing. However, in this inkjet technology the digital ink contains considerable amounts (25-50% by weight) of volatile organic compounds (VOC) as co-solvents, which are used in the ink to render its viscosity and wetness suitable for digital printheads. However, the process of curing and fixing the ink onto the fabric fibers is carried out at elevated temperatures of about 110-160° C., at which these solvents evaporate and create atmospheric pollution.

Water-based inks for inkjet commonly comprise co-solvents as humectants. Humectants for digital inks are typically chosen from the relative low weight glycol series for optimal performance in the printing processes. Since these glycols are mostly classified as volatile organic compounds (VOCs), they constitute a critical component that must be reduced due to improve human health and safety.

In many countries there are now standards that do not allow the establishment of factories that produces atmospheric pollution, and one of the solutions is to maintain a filtering facility or burn the VOC. Such facilities also emit carbon dioxide and/or consume energy that emit carbon dioxide, and therefore does not constitute a comprehensive environmental solution.

Hence, it is necessary to develop technology that will enable ink production for water-based inkjet inks that are suitable for digital printheads that contain minimal amounts of VOC.

Prior art documents pertaining to digital inkjet inks containing low-VOC contents include U.S. Pat. Nos. 4,072,644, 4,963,188, 5,316,575, 6,060,537, 6,221,933 and 6,544,322.

### SUMMARY OF THE INVENTION

According to an aspect of some embodiments of the present invention, there is provided a digital ink composition, which includes:
a dispersed pigment;
a binder/adhesion promoting agent;
a crosslinking agent;
an aqueous carrier;
at least 0.4 wt. % of non-volatile organic compound (VOC substitute) being a thickener, a rheology modifier and/or a humectant, having a boiling point higher than 250° C.; and
less than 20 wt. % of a volatile organic compound having a boiling point of less than 250° C.

In some embodiments, the composition includes less than 15 wt. % of the volatile organic compound having a boiling point of less than 250° C.

In some embodiments, the composition includes less than 15 wt. % of propylene glycol, diethylene glycol, triethylene glycol, ethylene glycol ethers, propylene glycol ethers and esters, cyclohexanone and isophorone.

In some embodiments, the composition is essentially devoid of ethylene glycol, ethylene glycol monobutyl ether, toluene, and/or butyl glycol.

In some embodiments, the composition is characterized by a dynamic viscosity and/or a Brookfield viscosity at printing temperature and/or a surface tension and/or an electrical resistance of the composition are/is suitable for inkjet printing process.

In some embodiments, the composition is characterized by at least one of:
a maximal particle size of less than 1 micron;
a dynamic viscosity at shear that ranges from 2 to 25 centipoise;
a Brookfield viscosity less than 25 centipoises at printing temperature;
a surface tension that ranges from 24 to 35 mN/m; and
an electrical resistance of 50 to 2000 ohm per centimeter.

In some embodiments, the composition is essentially devoid of an organic compound having a boiling point of less than 250° C.

In some embodiments, the composition is characterized by oscillation test values of G″ greater than G′ and η* greater than 100 at 35° C.

In some embodiments, the composition is having a total amount of solids ranging 10-30 wt. % of the total weight of the composition.

In some embodiments, the composition is characterized by viscosity ranging 10-15 cP.

In some embodiments, the VOC substitute is selected from the group consisting of polyethylene glycol, polyethylene oxide, polyvinyl alcohol, polyvinyl acetate, polyvinyl pyrrolidone, polysaccharide based polymers, cellulose, pullulan, dextran, arabinogalactan, chitosan, polyglycerol, synthetic associative urethane based HEUR, polyacrylates, and any combination or derivatives thereof.

In some embodiments, the composition further includes an alkali-soluble agent.

In some embodiments, the binder/adhesion promoting agent is the alkali-soluble agent.

According to an aspect of some embodiments of the present invention, there is provided a method of reducing VOC emission during digital printing of an image on a fabric, which is effected by:
providing at least one digital ink composition being characterized by:
having at least 0.4-10 wt. % of non-volatile organic compound (VOC substitute) serving in the ink composition as a thickener, a rheology modifier and/or a humectant, and the VOC substitute having a boiling point higher than 250° C.; and/or
having less than 20 wt. % of a volatile organic compound characterized by a boiling point of less than 250° C.,
and printing the image on the fabring using said at least one digital ink composition.

According to an aspect of some embodiments of the present invention, there is provided a method of reducing VOC emission during digital printing of an image on a fabric, which is effected by providing at least one low-VOC digital ink composition as provided herein; and printing the image on the fabring using said at least one digital ink composition.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### DESCRIPTION OF SOME SPECIFIC EMBODIMENTS OF THE INVENTION

The present invention, in some embodiments thereof, relates to water-based pigmented inks formulated for inkjet printing on fabrics, and more particularly, but not exclusively, to digital inkjet inks with low volatile organic compounds contents.

The principles and operation of the present invention may be better understood with reference to the accompanying descriptions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

While conceiving the present invention, the inventors set a goal to develop technology that will enable ink production for water-based inkjet printheads containing minimal amounts of, or no volatile organic compounds. For such technology, the inventors sought a substitute substance that can contribute two functions that the indefensible organic solvents in ink—viscosity and wetness. Thickening substances, or rheology modifiers, are used to adjust water-based formulas in a number of industries including the paint and coating industry, cosmetics industry and food industry. However, these thickeners are typically not suitable for injecting ink for various reasons, mainly due to their poor water solubility or if soluble, increasing the viscosity beyond the inkjet requirements. Another challenge is in jetting such compositions based on thickeners, in a reliable long-lasting way, as the industry expects. Hence, there are technological challenges to find the right thickeners and how to use them. Testing materials also exist in a number of industries and if so, additional materials must be found to match ink with inkjet technology. The present inventors envisioned that substitute thickeners will allow the production of inks for water-based inkjet printheads that will enable to design high-volume printers to several markets, including printing on white fabrics and printing on finished clothing while meeting strict air pollution standards without the need for facilities to dispose of volatile organic compounds.

As discussed hereinabove, digital textile pigment inks are composed of water-dispersed pigment, binder (glue), a carrier and additives. The carrier is typically a mixture of organic solvents and water, and constitutes about 25-50% of the weight of the ink composition. The role of organic co-solvents is to serve as a humectant that prevents the ink from drying at the top of the printhead, and to increase the viscosity of the ink composition to be suitable for inkjet. These solvents evaporate into the air during the curing of the ink on the fabric, which is carried out at a high temperature for a short time, creating an environmental hazard. The organic solvents used in this technology are typically from the glycolic family (polyalcohols and ethers thereof) as well as glycerin.

The term “volatile organic compound”, or VOC, as used herein, refers to a number of families of chemical substances that are recommended for exclusion or reduction in industrial processes, according to various regulatory criteria and definitions. For example, a regulatory definition of VOC can be found in 40 CFR 51.100. CFR—code of federal regulations, whereas the definition relates to the intent and requirements of the Clean Air Act. Excerpt from “Volatile Organic Compounds” Definition per 40 CFR Part 51.100(s), which is based on the substance's atmospheric photochemical reactivity. Different VOCs have different levels of reactivity. That is, they do not react to form ozone at the same speed or do not form ozone to the same extent. Some VOCs react slowly or form less ozone; therefore, changes in their emissions have limited effects on local or regional ozone pollution episodes. Some VOC are exempted from exclusion as these are considered to make a negligible contribution to ground-level ozone formation.

The VOC Solvents Emissions Directive at the European Union is the main policy instrument for the reduction of industrial emissions of volatile organic compounds (VOCs) in the European Union. It covers a wide range of solvent using activities, e.g. printing, surface cleaning, vehicle coating, dry cleaning and manufacture of footwear and pharmaceutical products. The VOC Solvents Emissions Directive requires installations in which such activities are applied to comply either with the emission limit values set out in the Directive or with the requirements of the so-called reduction scheme. Article 13 of The Paints Directive, approved in 2004, amended the original VOC Solvents Emissions Directive and limits the use of organic solvents in decorative paints and varnishes and in vehicle finishing products. The Paints Directive sets out maximum VOC content limit values for paints and varnishes in certain applications.

VOC's are responsible for the odor of scents and perfumes as well as pollutants. VOCs play an important role in communication between animals and plants, e.g. attractants for pollinators, protection from predation, and even inter-plant interactions. Some VOCs are dangerous to human health or cause harm to the environment. Anthropogenic VOCs are regulated by law, especially indoors, where concentrations are the highest. Most VOCs are not acutely toxic, but may have long-term chronic health effects.

In general, volatile organic compounds are organic chemicals that have a high vapor pressure at room temperature. High vapor pressure correlates with a low boiling point, which relates to the number of the sample's molecules in the surrounding air, a trait known as volatility. Since the use of the definition of VOC is related to regulation of such chemicals in specific countries, each jurisdiction may have a different definition of the term. For example:

In Canada, Health Canada classifies VOCs as organic compounds that have boiling points roughly in the range of 50 to 250° C. (122 to 482° F.). The emphasis is placed on commonly encountered VOCs that would have an effect on air quality.

The European Union defines a VOC as “any organic compound having an initial boiling point less than or equal to 250° C. (482° F.) measured at a standard atmospheric pressure of 101.3 kPa”.

The People's Republic of China defines a VOC as those compounds that have “originated from automobiles, industrial production and civilian use, burning of all types of fuels, storage and transportation of oils, fitment finish, coating for furniture and machines, cooking oil fume and fine particles (PM 2.5)”, and similar sources.

The Central Pollution Control Board of India released the Air (Prevention and Control of Pollution) Act in 1981, amended in 1987, to address concerns about air pollution in India. While the document does not differentiate between VOCs and other air pollutants, the CPCB monitors “oxides of nitrogen (NOx), sulfur dioxide (SO2), fine particulate matter (PM10) and suspended particulate matter (SPM)”.

In the United States the definitions of VOCs used for control of precursors of photochemical smog used by the U.S. Environmental Protection Agency (EPA) and state agencies with independent outdoor air pollution regulations include exemptions for VOCs that are determined to be non-reactive, or of low-reactivity in the smog formation process. Prominent is the VOC regulation issued by the South Coast Air Quality Management District in California and by the California Air Resources Board (CARB). However, this specific use of the term VOCs can be misleading, especially when applied to indoor air quality because many chemicals that are not regulated as outdoor air pollution can still be important for indoor air pollution. California's CARB uses the term “reactive organic gases” (ROG) to measure organic gases after public hearing in September 1995. The CARB revised the definition of “Volatile Organic Compounds” used in the consumer products regulations, based on their committee's findings.

In order to find general rules for selecting VOC substitutes suitable for use in digital ink compositions, the inventors have experimented with high boiling point solvents, which include oligomers and polymers of glycol and glycerin. These solvents were chosen since that resemble the original glycols in their effect on viscosity and wetness, and indeed the resulting inks had appropriate viscosity and wetness properties, however these inks were unstable when circulating inside the printheads.

The inventors have contemplated the large number of optional thickeners available on the market, such as water miscible polysaccharides, converted cellulose, dispersed polymeric emulsions based on acrylics, polyurethanes, and polyols, which are classified both by their polymeric building blocks and by being associative or non-associative, by their pH (like alkali-swellable emulsions) or by their Newtonian or non-Newtonian (pseudoplastic) characteristics. The inventors studied these type of thickeners to determine which are suitable for digital ink compositions in all terms of jettability (rheology, wetness and stability suitable for printing from a digital printhead, overall printed fabrics performance and wash-fastness, color vividness) and stability (long-term and during printing), while considering the somewhat opposing characteristic of a relatively high boiling point (low volatility). Among other, derivatives of urea, hygroscopic salts, and hygroscopic polymers have been considered. While considering the relatively narrow viscosity range of 4-20 cP, and more likely 10-17 cP, the present inventors have looked at substances characterized by their capability to increase viscosity of the water (to compensate for the reduction of the glycol ethers content), while under rheometric rotational shear, providing a Newtonian behavior, low affinity, and short molecular residue.

### Suitable VOC Substitutes:

A suitable VOC substitute can be selected based on its boiling point, which is preferably higher than 250° C., or higher than 280° C., or higher than 300° C.

A suitable VOC substitute can be selected based on its molecular weight, which is preferably lower than 100 kDa, lower than 80 kDa, lower than 60 kDa, or lower than 40 kDa.

A suitable VOC substitute should be selected based on its chemical compatibility with respect to all other components of the ink composition. As in general rule, the properties of the ink composition, such as colloidal stability, viscosity stability, should be maintained when substituting a VOC with a suitable VOC substitute. A suitable VOC substitute must not cause separation between the solids and the liquid carrier.

A suitable VOC substitute should be water soluble or dispersible at the effective concentration thereof.

A suitable VOC substitute should be colorless at the effective concentration thereof. Some thickeners that have some of the properties suitable for use as VOC substitutes add amber-yellow color to the ink composition, rendering these substances incompatible with the requirements for a suitable VOC substitute in some or most ink compositions, especially in white inks.

As discussed hereinabove, the main humectants used in water-based digital inks are glycol ethers that are regarded as VOCs in the industrial context. The roles of such VOCs include bestowing the required viscosity and the required wetness that influences the drying rate of the inkjet, which are critical for smooth performance within the inkjet printhead. Reducing the VOCs' content by using thickeners as suitable VOC substitutes, should compensate for the loss of these key properties. The desirable “thickeners” should thus exhibit some basic properties by which suitable VOC substitute thickeners can be selected.

A suitable VOC substitute can be selected capable of bestowing a jettable viscosity (10-20 cP at printing conditions as required by the printhead design) to the ink composition, comprising primarily water and dispersed solids (pigment, resin binder polymeric emulsion, etc.).

A suitable VOC substitute can be selected capable of bestowing a high shear property to the resulting ink composition. From rheology consideration, a digital inkjet ink composition is placed under high shear in the piezo-based drop-jetting device in the printhead, requiring the ink to exhibit a Newtonian flow regime. Thus, suitable VOC substitutes are also selected by their high shear properties. As empirically demonstrated in the Examples section below, maintaining a Newtonian flow throughout the increasing shear rate is a good selection criteria for selecting a suitable VOC substitute. Although some pseudoplastic thickeners (in behavior) were used successfully as suitable VOC substitutes, the more Newtonian a suitable VOC substitute is, the better the ink composition performs in the printhead.

A suitable VOC substitute can be selected based on an oscillation test that can predict jetting performance, using test parameters such as time (20 min), and shear (0.01 kHz) at 35° C. and other air conditions. This test represents Newtonian/non Newtonian behavior that can be observed as function of time and applied low shear. Main parameters of the test are n (eta; apparent or shear viscosity) which represents modulus of complex viscosity (the shear stress applied to a fluid divided by the shear rate), G′ that represents clastic modulus, and G″ that represents loss modulus. Steep increase in η (depended on G′ and G″) over time indicates non-Newtonian behavior of the formulation during jetting, which might lead to accumulation issues of the formulation on orifice plate, high open time during jetting (i.e. jetting issues), nozzles clogging, gelation formation, unintended solidification and the likes.

A suitable VOC substitute should be selected based on its compatibility with wet-on-wet printing methodology. In the context of some embodiments of the present invention, an ink composition comprising s VOC substitute is printed in conjunction with an ink immobilization composition which causes the ink to coagulate upon contact on the surface of the substrate. The immobilization composition typically includes an acid that lowers the pH of the environment of the ink composition, causing an acid-sensitive alkali component in the ink composition to coagulate. Hence, a VOC substitute used in the ink composition should be compatible with an alkali composition, and be stable at basic pH (above 7.5) since the ink composition is alkali. A suitable VOC substitute should be stable in alkali environment in order to deliver consistent properties over time, without adversely affecting the coagulating dynamics of the ink composition.

As demonstrated in the Examples section below, PVA (PVA-PVAcetate) was found capable of fulfilling some of the above requirements, yet failed to maintain the coagulation dynamics of the ink composition, since PVA caused the ink composition to lose its ability to coagulate upon coming in contact with the acidic immobilization composition which was applied on the substrate (fabric).

In the context of the present invention, suitable VOC substitutes, which can compensate for both viscosity (as thickeners) and humectant loss of the reduced VOCs, in digital ink compositions, include glycerin (glycerin can replace mono ethylene glycol (MEG), and di-ethylene glycol (DEG)), polyvinylpyrrolidone (PVP), and polyurethane oligomers (such as Coexel TH1000 and Coexel TH1500) and materials of the following families: natural based thickeners (cellulosic substances, polysaccharides, alginates, gelatins, all having a molecular weight lower than 100 kDa), cellulose ethers having a molecular weight lower than 100 kDa, and synthetic thickeners having a molecular weight lower than 100 kDa.

Synthetic thickeners that can be used as VOC substitutes in the context of the present invention include:
Polyethylene oxide, its derivatives and other synthetic polymers
Polyurethane (PU) oligomers having a molecular weight lower than 100 kDa;
Non-associative, alkali swellable emulsions (ASE), mostly acrylics acrylates and their derivatives;
Associative hydrophobically modified alkali-swellable emulsion (HASE) that are similar as the ASE group, only with a hydrophobic parts added to the polymers, allowing them another degree of resistance under shear (meaning—higher viscosity power);
Associative hydrophobically modified urethane-ethoxylate (HEUR) that are mainly PU, but also polyethers and others.

The volatility of the VOC substitutes, according to some embodiments of the present invention, is selected such that the printing process would emit as little vapors as possible to the environment. Volatility itself has no defined numerical value, but it is often described using vapor pressures or boiling points (for liquids). High vapor pressures indicate a high volatility, while high boiling points indicate low volatility. Vapor pressures and boiling points are often presented in tables and charts that can be used to compare chemicals of interest. Volatility data is typically found through experimentation over a range of temperatures and pressures.

Vapor pressure is a measurement of how readily a condensed phase forms a vapor at a given temperature. A substance enclosed in a sealed vessel initially at vacuum (no air inside) will quickly fill any empty space with vapor. After the system reaches equilibrium and no more vapor is formed, this vapor pressure can be measured. Increasing the temperature increases the amount of vapor that is formed and thus the vapor pressure. In a mixture, each substance contributes to the overall vapor pressure of the mixture, with more volatile compounds making a larger contribution.

Boiling point is the temperature at which the vapor pressure of a liquid is equal to the surrounding pressure, causing the liquid to rapidly evaporate, or boil. It is closely related to vapor pressure, but is dependent on pressure. The normal boiling point is the boiling point at atmospheric pressure, but it can also be reported at higher and lower pressures.

Another factor influencing a substance's volatility is the strength of the interactions between its molecules. Attractive forces between molecules are what holds materials together, and materials with stronger intermolecular forces, such as most solids, are typically not very volatile. For example, ethanol and dimethyl ether, two chemicals with the same formula (C₂H₆O), have different volatilities due to the different interactions that occur between their molecules in the liquid phase: ethanol molecules are capable of hydrogen bonding while dimethyl ether molecules are not. The result in an overall stronger attractive force between the ethanol molecules, making it the less volatile substance of the two.

In general, volatility tends to decrease with increasing molecular mass because larger molecules can participate in more intermolecular bonding, although other factors such as structure and polarity play a significant role. The effect of molecular mass can be partially isolated by comparing chemicals of similar structure (i.e. esters, alkanes, etc.). For instance, linear alkanes exhibit decreasing volatility as the number of carbons in the chain increases.

Suitable VOC substitutes, according to some embodiments of the present invention, include, without limitation, polyethylene glycol, polyethylene oxide (e.g., RheoBYK 100), polyvinyl alcohol, polyvinyl pyrrolidone, polysaccharide based polymers (e.g., Methocel, Walocel, Cellosize, CMC, Bermocoll), cellulose, pullulan, dextran, arabinogalactan, chitosan, polyglycerol, synthetic associative urethane based HEUR (e.g., Coexel TH-622N, Coexel TH1000, Coexel TH1500, Coexel TH1009, Byk Optiflow 1000, Aerysol), polyacrylates (e.g., Rheovis, Rheolate), and derivatives thereof.

### Low-VOC Digital Ink Composition:

In the context of some embodiments of the present invention, a VOC may be regarded as an organic compound having a boiling point of less than 250° C. Non-limiting examples of VOCs which are relevant to digital ink compositions include propylene glycol, diethylene glycol, triethylene glycol, ethylene glycol ethers, propylene glycol ethers and esters, and ketones such as cyclohexanone and isophorone. In the context of the present invention, the digital ink composition comprises as little as possible or none of these VOCs.

According to some embodiments, the ink composition provided herein contains none of, or at least is essentially devoid of, ethylene glycol, ethylene glycol monobutyl ether, toluene, and/or butyl glycol. It is noted that these VOCs are known to be useful for digital ink compositions, but are gradually being regulated-out and are becoming forbidden for industrial use under the Restricted Substance Lists (RSL) which is adopted by several global firms.

According to some embodiments, the ink composition provided herein contains none of, or at least is essentially devoid of substances that are listed as harmful substances under the “Standard 100 by OEKO-TEX®”, which is publically accessible world-wide (via the internet), and being adopted and accepted by health-aware firms around the world. Harmful substances within the context of this standard refer to substances which may be present in a textile product or accessory and exceed a maximum amount or which evolve during normal and prescribed use and exceed a maximum amount, and which may have some kind of effect on people during normal and prescribed use and may, according to current scientific knowledge, be injurious to human health.

In the context of some embodiments of the present invention, a “VOC substitute” is defined as a non-volatile thickener, a non-volatile rheology modifier and/or a non-volatile humectant, whereas a preferred VOC substitute acts as a thickener, a rheology modifier and a humectant, and having a boiling point of higher than 250° C.

Most of the properties of the digital ink compositions provided herein are meant to resemble VOC-containing digital ink compositions in terms of pigment content (e.g., about 20 wt. %), film-forming and substrate adhesion mechanism, pH, and the likes. The desired propertied bestowed by the VOC substitute(s) should be achieved at a relatively low concentration thereof, compared to the concentration of the VOC that is replaced.

Hence, according to some embodiments of the present invention, a digital ink composition that is referred to herein as a “low-VOC digital ink composition”, contains less than 20 wt. % VOC of the total weight of the ink composition, or less than 15 wt. % VOC, less than 10 wt. %, less than 5 wt. % or less than 1 wt. % VOC of the total weight of the ink composition. According to some embodiments of the present invention, the low-VOC digital ink composition is essentially devoid of a volatile organic compound.

In some embodiments of the present invention, the desired ink properties are achieved by using 0.1-20 wt. % VOC substitute(s) of the total weight of the ink composition, and preferable 5-15 wt. %, or 10-15 wt. % of the total weight of the ink composition.

An ink composition using a preferred VOC substitute, according to some embodiments of the present invention, is characterized by oscillation test results G″ greater than G′ and η* greater than 100 at 35° C.

The total amount of solids in the herein provided low-VOC digital ink compositions ranges 10-30 wt. %. In some preferred embodiments, total amount of solids ranges 10-20 wt. % of the total weight of the digital ink composition, or 12-25 wt. %, or 15-20 wt. %, or 15-30 wt. %, or 10-20 wt. %.

According to some embodiments of the present invention, the digital ink composition comprises less than 100%, less than 90%, less than 80%, less than 70%, less than 60%, less than 50%, less than 40%, less than 30%, less than 20%, or less than 10% of the VOC contents compared to an equivalent ink. For an exemplary digital ink composition having less than 30% of the VOC contents compared to an equivalent ink composition, see Example 3 in the Examples section that follows below.

The total amount of thickeners in the herein provided low-VOC digital ink compositions ranges 0.4-15 wt. %. In some preferred embodiments, total amount of thickeners ranges 0.5-8 wt. % of the total weight of the digital ink composition, or 1-6 wt. %, or 2-6 wt. %, or 4-10 wt. %, or 5-8 wt. %.

The viscosity of the herein provided low-VOC digital ink compositions ranges 10-15 cP, or 11-14 cP.

Exemplary formulations for acrylic-based and polyurethane-based digital ink compositions are presented in Table 1 below.

TABLE 1

| | Acrylic based | Polyurethane based |
|---|---|---|
| Composition | formulation | formulation |
| Aqueous carrier: | Ethylene glycol | Ethylene glycol |
| | 10-15 wt. % | 10-15 wt. % |
| | Propane triol: 4-5 wt. % | Propane triol: 4-5 wt. % |
| | DI Water to QS | DI Water to QS |
| VOC substitute | Pluriol PPG 2-10 wt. % | Pluriol PPG 2-10 wt. % |
| (thickener) | PVP 0-3 wt. % | PVP 0-3 wt. % |
| pH adjusting | Amino methyl propanol | Butyl diethanol amine |
| agent | 0.1-0.5 wt. % | 0.1-0.5 wt. % |
| Binder | Polyacrylate 30-40 wt. % | Polyurethane 30-40 wt. % |
| Crosslinker | Desmodur XP 2802 | Desmodur XP 2802 |
| | 2-5 wt. % | 2-5 wt. % |
| Surfactant | BYK 349 0.1 wt. % | BYK 349 0.1 wt. % |

### A Method for Reducing VOC Emission During Digital Printing:

According to another aspect of the present invention, there is provided a method for reducing VOC emission during digital printing an image on a substrate (for example, a fabric), the method is effected essentially by using the low-VOC digital ink compositions provided herein. Alternatively, there is provided a method for printing an image on a substrate (for example, a fabric), using a low-VOC digital ink composition, as provided herein.

In some embodiments, the low-VOC digital ink compositions are formulated as described herein, by selecting VOC substitutes as defined herein that replace the VOCs typically used in digital ink formulations. A method for reducing VOC emission during digital printing can therefore be effected by providing low-VOC digital ink compositions, as these compositions are provided herein, and using these ink compositions in the digital printing process instead of the regular (high-VOC content) digital ink compositions typically used in digital printing. Alternatively, the method can be effected by replacing VOC ingredients in the digital ink composition with VOC substitutes, as these are defined and exemplified herein, thereby providing a low-VOC digital ink composition.

Once low-VOC digital ink compositions are provided, the printing process can be effected essentially as digital printing is effected using regular in composition.

It is expected that during the life of a patent maturing from this application many relevant digital ink compositions with low-VOC contents will be developed and the scope of the term “low-VOC digital ink composition” is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or, in the alternative, includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental and/or calculated support in the following examples.

### EXAMPLES

Reference is now made to the following examples, which together with the above descriptions illustrate some embodiments of the invention in a non-limiting fashion.

### Example 1

### Materials and Methods

A proof of concept of some embodiments of the present invention was carried out by preparing a series of digital ink compositions using various combinations of VOC substitutes.

Thickener of the synthetic linear polymers family included PVP and PVA (Kurrary, Japan).

Thickener of the cellulosic based polymers family included CELLOSIZE™ (hydroxyethyl cellulose), METHOCEL™ and WALOCEL™ M (DOW Inc.), which represent a broad range of cellulose ether formulations including methylcellulose, hydroxypropyl methylcellulose and hydroxyethyl methylcellulose. Also from the family of cellulosic polymers are the BERMOCOLL™ nonionic cellulose ethers (Akzo Nobel Pakistan Limited), which include EHEC (ethyl hydroxyethyl cellulose, E and EBS), MEHEC (methyl ethyl hydroxyethyl cellulose, M, EM and EBM), and HM-EHEC (hydrophobical modified ethyl hydroxyethyl cellulose, EHM).

Additional cellulosic agents included AQUALON™ and BLANOSE™ (Ashland Inc.) carboxymethylcellulose (CMC), and alginates (Algaia LTD) that included SATIALGINE®, ALGOGEL® and CECALGUM™.

Thickener of the polyethylene oxides (PEOs) family included POLYOX™ WSR (Dow), which is a water soluble PEG-90M with a relatively low molecular weight; ALKOX® resins (Meisei Chemical Works, Ltd.), which are high molecular weight poly(ethylene oxide); Polyglycerols (Spiga Nord S.p.A.), which are inter-molecular glycerol ethers; and members of the RHEOBYK product line (BYK), which are modified PEG used as rheology modifiers for non-polar to medium-polarity carriers.

Thickener of the synthetic associative hydrophobic emulsified urethane based family included hydrophobically modified urethane-ethoxylate (HEUR) such as OPTIFLO™ (Byk), COEXEL™ (San Nopco), ACRYSOL™ (Dow), SOLTHIX™ (Lubrizol) and ESPESILOR™ (Cromogenia).

### Oscillation Measurement:

The purpose of the oscillation test is to evaluate the reaction of the ink to a mild oscillation stress. This reaction can predict an “open time” (jetting parameter, see in Tables 1 and 2) or gel-formation issues, in search for an optimal ink formulation. Hence, the oscillation test is a tool for selecting and formulating inks with VOC substitutes.

Briefly, oscillation test measurements allow to measure the resultant stress response by applying “sinusoidal shear” deformation in the sample. The measurement is performed over about 20 minutes at 35° C., and simulates about 40 minutes of behavior at room temperature at low humidity. During the measurement a very small torque of 10 mPa is applied to the sample with frequency 0.5 Hz. When oscillation time ends, the software calculates average of G′, G″ and η* by time, and gel point (if exists). G′ represents storage modulus, while G″ is loss modulus and η (eta) is the ratio between G′ and G″. If G′ is dominant and increases above 100 Mpa, it means that the elastic behavior of the tested formulation is solid-like. Besides, storage modulus G′ additionally a complex viscosity η* is also obtained from this oscillation experiment.
G″>G′ material is liquid or sol-like; and
G′>G″ material is solid or gel-like.

In the context of the present invention, preferable G′ values are up to 60 Mpa, and η* is up to 30 cps. Incidentally, ink compositions having G′ and η* of 100-1000 and higher can be jetted, but less preferred due to jetting issues.

### Example 2

### Acrylic Binder Based Inks

Table 2 presents a series of acrylic binder based ink formulations, presenting the contents of the ingredients in weight percentage relative to the weight of the composition. The VOC components in the “VOC reference” formulation include mono/di-ethylene glycol and propylene glycol and the VOC substitutes include glycerin, polyethylene oxide, cellulosic based polymers, synthetic associative urethane based hydrophobic emulsified urethane, and PVP-40.

TABLE 2

| | VOC | | | | | |
|---|---|---|---|---|---|---|
| Composition | reference | AC1 | AC1-0 | AC2 | AC3 | AC4 |
| Mono/Di-ethylene glycol | 35 | | | | | |
| (B.P. 197/244° C.) | | | | | | |
| Propylene glycol (B.P. 188.2° C.) | | 15 | 10 | 10 | 10 | 10 |
| Glycerin (B.P. 290° C.) | | 4.5 | 4.5 | 4.5 | 4.5 | 4.5 |
| Polyethylene oxide | | | 6 | | | |
| Cellulosic based polymers | | | | | | 1.45 |
| (~90% solid) | | | | | | |
| Synthetic associative urethane based | | | | 12.5 | 18 | |
| hydrophobic emulsified urethane | | | | | | |
| (33% solid) | | | | | | |
| PVP-40 (40% solids in water; | 2.5 | 4 | 2 | | | |
| polyvinylpyrrolidone average mol. | | | | | | |
| wt. 40,000) | | | | | | |
| pH adjusting agent | 0.4 | 0.4 | 0.4 | 0.4 | 0.4 | 0.4 |
| acrylic binder (40% solids) | 42.037 | 40 | 40 | 34 | 40 | 40 |
| Crosslinking agent | 1 | 5 | 5 | 3 | 3 | 3 |
| additives | 3 | 3 | 2 | 3 | 3 | 3 |
| wetting agent | | 0.2 | 0.2 | 0.2 | 0.2 | 0.2 |
| Pigment (20% solid) | 12 | 12 | 12 | 12 | 12 | 12 |
| DI Water | to QS | to QS | to QS | to QS | to QS | to QS |
| % thickener | 1.0 | 1.6 | 7 | 4.1 | 5.9 | 1.3 |
| % solid | 19.2 | 19.0 | 24 | 15.0 | 17.4 | 17.4 |
| Viscosity (cP) @28 C. | 12 | 12.2 | 12 | 13.3 | 14.7 | 10.7 |
| Oscillation test (Etaₘₐₓ) | <100 | 2500 | <100 | 5-10K | 5-10K | 100K |

As can be seen in Table 2 above, the contents of the VOC component, mono/di-ethylene glycol, was reduced to null, and replaced with a smaller amount of propylene glycol (a less hazardous VOC), and the above-mentioned VOC substitutes to afford a working reduced VOC digital ink composition, according to some embodiments of the present invention.

### Example 3

### Polyurethane Binder Based Inks

Table 3 presents a series of polyurethane binder based ink formulations, presenting the contents of the ingredients in weight percentage relative to the weight of the composition. The VOC components in the “VOC reference” formulation is propylene glycol, and the VOC substitutes include glycerin, cellulosic based polymers, synthetic associative urethane based hydrophobic emulsified urethane, polyvinyl alcohol (PVA), and polyvinylpyrrolidone (PVP-40). The oscillation test (Etaₘₐₓ) refers to ratio between Storage modulus and Loss modulus measured under applied conditions using Rheometer. Etaₘₐₓ values below 100 indicate stable formulation, or no change in viscosity as function of applied conditions.

TABLE 3

| | VOC | | | | |
|---|---|---|---|---|---|
| Formula | reference | PU1 | PU2 | PU3 | PU4 |
| Propylene glycol | 32 | 10 | 10 | 10 | 10 |
| Glycerin | 4.5 | 4.5 | 4.5 | 4.5 | 4.5 |
| Cellulosic based polymers | | | 2.1 | | |
| (~90% solid) | | | | | |
| Synthetic associative | | | | | 8 |
| urethane based | | | | | |
| hydrophobic emulsified | | | | | |
| urethane (33% solid) | | | | | |
| PVA (10 wt. % solution | | | | 23 | |
| in water) | | | | | |
| PVP-40 (40% solids) | 2 | 12 | | | |
| in water | | | | | |
| pH adjusting agent | 0.1 | 0.1 | 0.1 | 0.1 | 0.1 |
| polyurethane binder | 33 | 33 | 33 | 33 | 33 |
| dispersion | | | | | |
| (40% solids) | | | | | |
| crosslinker (38% solids) | 3 | 3 | 3 | 3 | 3 |
| additives | 2 | 2 | 2 | 2 | 0.2 |
| Pigment (20% solid) | 5 | 5 | 5 | 5 | 5 |
| DI Water | to QS | to QS | to QS | to QS | to QS |
| % thickener | 0.8 | 4.8 | 1.9 | 2.3 | 2.6 |
| solids % | 16.1 | 20.1 | 17.2 | 17.6 | 18.0 |
| Viscosity (cP) @28 C. | 11.6 | 11.4 | 12.8 | 11.3 | 12.1 |
| Oscillation test (Etaₘₐₓ) | <100 | <100 | 100K | 9K | 5-10K |

As can be seen in Table 3 above, the contents of the VOC component, propylene glycol, was reduced from 32 wt. % to 10 wt. % (about 70% reduction, or about 30% of the VOC content compared to the VOC-containing reference composition), and replaced with the above-mentioned VOC substitutes to afford a working reduced VOC digital ink composition, according to some embodiments of the present invention.

### Example 4

### Low-VOC White Digital Ink Composition

Table 4 presets an exemplary white digital ink composition, according to some embodiments of the present invention.

TABLE 4
White ink composition

| | |
|---|---|
| Titania (as an opaque white pigment) | 18% |
| Propylene glycol | 15% |
| Glycerin | 4.5% |
| Appretan E 6200 as acrylic binder | 37% |
| Blocked isocyanate (38% solid - | 3% |
| cross-linking agent) | |
| Tego 750 (dispersant) | 3.2% |
| Polyvinylpyrrolidone average mol wt 40,000 | 4% |
| (40% solids) in H2O | |
| Amino methyl propanol (as a buffering agent) | 0.2% |
| BYK 349 (as a wetting agent/surfactant) | 0.1% |
| Acticide MBS (as a bacteriocide/fungicide) | 0.1% |
| Deionized water | to 100% |
| Viscosity at 28° C. | 12 cp |
| G′ | 15 |
| G″ | 90 |

### Example 5

### Low-VOC Colored Digital Ink Composition

Table 5 presets an exemplary colored digital ink composition, according to some embodiments of the present invention.

TABLE 5
Colored (CMYK) ink composition

| | |
|---|---|
| Cabbojet 260 series (20% pigment in water) | 12% |
| Propylene glycol | 10% |
| Glycerin | 4.5% |
| NeoRez ® R-1007 (DSM) polyurethane | 40% |
| binder (40% solid) | |
| Blocked isocyanate (38% solid - | 3% |
| cross-linking agent) | |
| Polyvinyl alcohol | 3% |
| Butyl diethanol amine (as a buffering agent) | 0.2% |
| BYK 349 (surfactant) | 0.10% |
| Acticide MBS (as a bacteriocide/fungicide) | 0.1% |
| Deionized water | to 100% |
| Viscosity at 28° C. | 11 cp |
| G′ | 10 |
| G″ | 80 |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A digital ink composition formulated for inkjet printing on fabrics, comprising:
a dispersed pigment;
a binder/adhesion promoting agent;
a crosslinking agent;
an aqueous carrier;
at least 0.4-10 wt. % of non-volatile organic compound (VOC substitute) being a thickener, a rheology modifier and/or a humectant, having a boiling point higher than 250° C.; and
less than 20 wt. % of a volatile organic compound having a boiling point of less than 250° C.

2. The composition of claim 1, comprising less than 15 wt. % of said volatile organic compound having a boiling point of less than 250° C.

3. The composition of claim 1, comprising less than 15 wt. % of propylene glycol, diethylene glycol, triethylene glycol, ethylene glycol ethers, propylene glycol ethers and esters, cyclohexanone and isophorone.

4. The composition of claim 1, comprising less than 5 wt. % of any one of ethylene glycol, ethylene glycol monobutyl ether, toluene, and/or butyl glycol.

5. The composition of claim 1, wherein a dynamic viscosity and/or a Brookfield viscosity at printing temperature and/or a surface tension and/or an electrical resistance of the composition are/is suitable for inkjet printing process.

6. The composition of claim 1, being characterized by at least one of:
a maximal particle size of less than 1 micron;
a dynamic viscosity at shear that ranges from 2 to 25 centipoise;
a Brookfield viscosity less than 25 centipoises at printing temperature;
a surface tension that ranges from 24 to 35 mN/m; and
an electrical resistance of 50 to 2000 ohm per centimeter.

7. The composition of claim 1, essentially devoid of an organic compound having a boiling point of less than 250° C.

8. The composition of claim 1, characterized by oscillation test values of G″ greater than G′ and η* greater than 100 at 35° C.

9. The composition of claim 1, having a total amount of solids ranging 10-30 wt. % of the total weight of the composition.

10. The composition of claim 1, characterized by viscosity ranging 10-15 cP.

11. The composition of claim 1, wherein said VOC substitute is selected from the group consisting of mono ethylene glycol (MEG), di-ethylene glycol (DEG), glycerin, polyvinylpyrrolidone (PVP), a polyurethane oligomer, a polysaccharide, an alginate, a gelatin, polyethylene glycol, polyethylene oxide, polyvinyl alcohol, polyvinyl pyrrolidone, polysaccharide based polymers, cellulose and ethers thereof having a molecular weight lower than 100 kDa, pullulan, dextran, arabinogalactan, chitosan, polyglycerol-, synthetic associative urethane based HEUR, polyacrylates, and any combination thereof.

12. The composition of claim 1, further comprising an alkali-soluble agent.

13. The composition of claim 12, wherein said binder/adhesion promoting agent is said alkali-soluble agent.

14. A method of reducing VOC emission during digital printing of an image on a fabric, the method comprising:
providing at least one digital ink composition being characterized by:
having at least 0.4-10 wt. % of non-volatile organic compound (VOC substitute) being a thickener, a rheology modifier and/or a humectant, said VOC substitute having a boiling point higher than 250° C.; and/or
having less than 20 wt. % of a volatile organic compound having a boiling point of less than 250° C. and
printing the image on the fabric using said at least one digital ink composition.

15. A method of reducing VOC emission during digital printing of an image on a fabric, the method comprising:
providing at least one digital ink composition of claim 1; and
printing the image on the fabric using said at least one digital ink composition.
